(19) United States
(12) Patent Application Publication
(10) Pub. No.: US 2007/0147233 A1
(43) Pub. Date: Jun. 28, 2007

(54) Graceful failover mechanism for SSCOP service access point for SS7 links

(76) Inventor: Tolga Asveren, Bordentown, NJ (US)

Correspondence Address: BLANK ROME LLP, 600 NEW HAMPSHIRE AVENUE, N.W., WASHINGTON, DC, 20037, US

(21) Appl. No.: 11/315,313

(22) Filed: Dec. 23, 2005

(51) Int. Cl. H04L 12/26; H04J 3/14

(52) U.S. Cl. 370/220; 370/236

(57) ABSTRACT

The invention includes two hosts having synchronized information to provide graceful failover for an SSCOP Service Access Point. Each host connected to the same SSCOP SS7 link, and has a Link Manager, SSCF-NNI layer, and SSCOP layer. For each link, there is an instance of SSCF-NNI state machine running in stack and similarly for each link there is an instance of SSCOP state machine running in the stack. Once the Link Manager detects that the active host on the redundancy group for SS7 links has failed, it checks its list of links, whether the failed host was the active host for those links and whether the links were active. If the Link Manager determines that the active host has failed and the links were active, it informs the SSCF-NNI and the SSCOP, which then switch the corresponding state machine from a default “Idle” state to an “In Service” and “Outgoing Recovery Pending” state respectively. By following the procedures defined for SSCOP in Q.2110 after this point on, SSCOP state machine eventually switches to “Data Transfer Ready” state and the standby host thereby becomes the active host in a transparent manner to the SSCOP user.

### BACKGROUND OF THE INVENTION

1. Field of the Invention

The present invention relates to a failover mechanism for uncontrolled failovers for SSCOP Service Access Point. More particularly, the present invention relates to a system and method for graceful failover for SSCOP Service Access Points to provide graceful SS7 Link Service Access Point failover for SS7 Links using ATM through SSCF-NNI/SSCOP.

2. Background of the Related Art

Signaling System 7 (SS7) is a protocol suite designed for signaling in telecommunications networks. It generally consists of various protocols which are used at different layers within the network system. The protocols include: MTP1 (Message Transfer Part), MTP2, MTP3, SCCP (Signaling Connection Control Point), ISUP (ISDN User Part), and TCAP (Transaction Capabilities Application Part). FIG. 4 illustrates the various levels of operation for these protocols, where SCCP and ISUP are also referred as User Parts.

Asynchronous Transfer Mode (ATM) is an International Telecommunication Union-Telecommunications Standards Section (ITU-T) standard for cell relay wherein information for multiple service types, such as voice, video, or data, is typically conveyed in small, fixed-size cells. ATM technology is generally used for local and wide area networks (LANs and WANs) and supports the realtime communication of voice, video, and data.

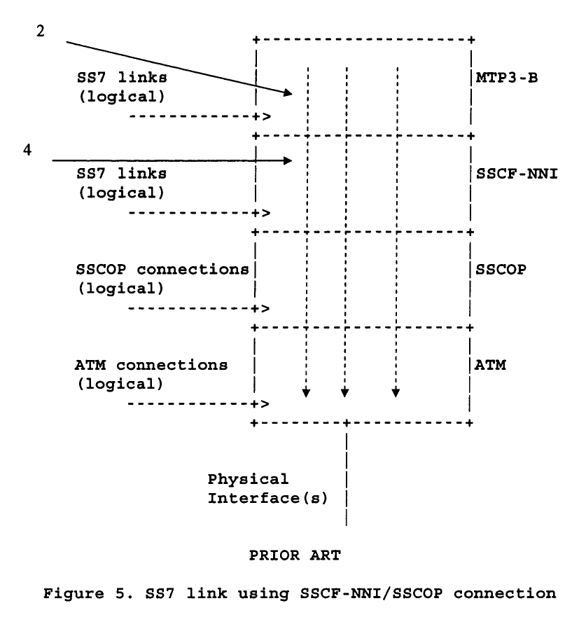

SSCOP and SSCF-NNI are protocols which are utilized with ATM technologies. For instance, as shown in FIG. 5, SS7 nodes can utilize SS7 links running on top of ATM, by making use of SSCF-NNI and SSCOP protocols. The downward facing arrows represent the flow of messages. Thus, for example, when MTP3-B wants to send a message to the network for a SS7 link, it passes this message to SSCF-NNI. SSCF-NNI passes the message to SSCOP. On the SSCOP layer, each SS7 link corresponds to a SSCOP connection. The SSCOP layer passes the message to the ATM layer, where the message is sent to the network by utilizing the corresponding ATM connection. The links and connections shown in the figure represent logical entities. The links represent communication channels between two SS7 entities, whereas the connections represent communication paths between two SSCOP or ATM entities.

The boxes labeled as MTP3-B, SSCF-NNI, SSCOP and ATM represent one instance of the corresponding protocol stack. The SSCOP (Service Specific Connection Oriented Protocol) stack instance provides reliable message delivery, including such functionalities as sequence integrity, error correction by selective retransmission, flow control, error reporting, keep alive, local data retrieval, connection control, transfer of user data, protocol error detection, and recovery and status reporting. SSCF-NNI (Service Specific Coordination Functions for Network-to-Network Interface signaling) provides functionalities such as establishment and release of connections, and signaling link error monitoring. SSCOP is defined by the ITU in document Q.2110, and SSCF-NNI is defined by the ITU in document Q.2140.

Advanced Telecommunications Computing Architecture (ATCA) is an industry initiative developed by PICMG (PCI Industrial Computer Manufacturers Group). ATCA defines a standard chassis form factor, intra-chassis interconnections, and platform management interfaces suitable for high-performance, high bandwidth computing and communications solutions.

ATCA uses the concept of Protection Groups (also referred to as Redundancy Group) in the context of redundancy. A Protection Group is a group of ATCA elements, which provide the same service and are exact replicas of each other from a network point-of-view, i.e., logically they have the same interfaces. Interface level redundancy is hidden from higher layers of application software so that switchovers (or failovers) from one physical interface to another one do not impact the functions of the higher layer services. This may be accomplished by exposing a single service interface to application software. This service interface should always be associated with the currently active physical interface. A switchover should result in a change in the mapping between the service interface and the physical interface it is associated with, but should not impact higher level software that is dependent on the service interface. Furthermore, having failovers in a transparent way to peer network entities is also a desirable feature.

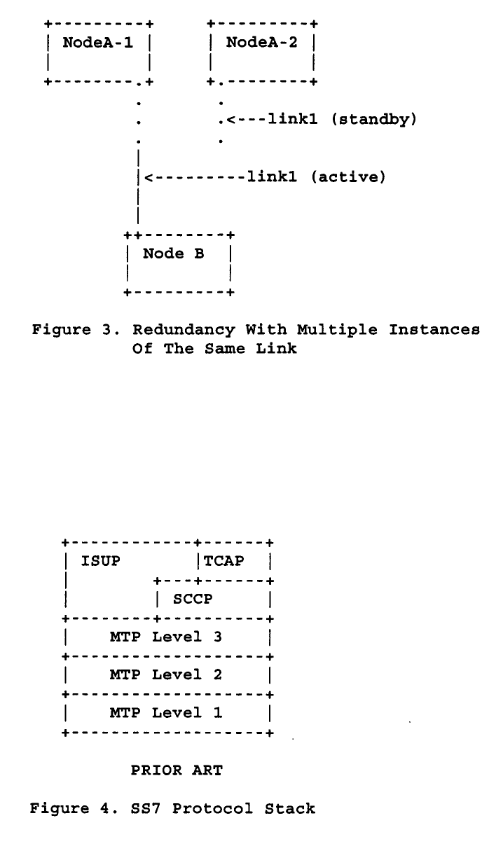

The principle of a Protection Group has been applied to SS7 systems, where SS7 links running over ATM through SSCF-NNI/SSCOP are utilized, and a replica of a link on another physical entity provides redundancy to network and MTP3-B/SS7 User Parts, as shown in FIG. 3. However, no graceful SSCOP SAP failover support is provided, and the switchover between the replicas of the same link (for example, when the active replica fails) was not transparent. The SSCOP connection is dropped during failover, which is visible to both the local and remote SSCOP users, and causes the SS7 link to go down. This will be visible to MTP3-B and would cause SS7 link to go down also on the remote side.

It is not practical to synchronize the state for the SSCOP connection replicas used to transfer traffic for SS7 link, because that would require state updates on SSCOP for each sent/received message Being a transport layer protocol ensuring reliable and ordered message delivery, SSCOP keeps state variables which are updated with each sent and received message. To synchronize a SSCOP connection on different hosts, one would need to update those variables for each sent and received message, which would cause an enormous amount of overhead.

However, failing the SSCOP connection during switchover won't be transparent to local upper layers/remote peers since SS7 link would fail, the MTP3-B would be notified about link failure and would possibly notify the SS7 User Parts that the reachability information for a destination has changed. The link on the remote peer would also fail and similar notifications/indications would be visible by remote MTP3-B/SCCP, ISUP. For instance, a peer could be any SS7 entity, with which the local entity is communicating over SS7 links, e.g., Signaling Switching Point (SSP), Service Control Point (SCP), and Mobile Switching Center (MSC).

It should be noted that redundancy provided by the Protection Group approach is different than the redundancy provided by SS7 with multiple links in a linkset. In a Protection Group (FIG. 3), there are two instances of the same link, whereas the links in a linkset (FIG. 2) are actually different links.

### SUMMARY OF THE INVENTION

Accordingly, it is an object of the invention to provide a system and method for graceful (i.e., essentially transparent) failover for SSCOP SAP. It is another object of the invention to provide a failover of an SSCOP SAP that is transparent to SSCOP users. It is yet anther object of the invention to provide a graceful failover for SS7 links running on top of SSCF-NNI and SSCOP.

In accordance with these and other objects, the present invention includes two hosts having synchronized information. Each host is utilizing the same SS7 link running on top of the same SSCOP connection, and has a Link Manager, SSCF-NNI layer, and SSCOP layer. For each layer, there is a corresponding state machine which is maintained according to the procedures defined in the related standards specifications. Once the Link Manager detects that a host on the redundancy group has failed, it checks its list of links, whether the failed host was the active host for any of those links.

If the Link Manager determines that the failed host had the active role for any of the links and if the status of that link as communicated previously by the failed host was active, it informs the SSCF-NNI and the SSCOP, which then switch the corresponding state machine from “Idle” state to “In Service” state for the SSCF_NNI and to “Outgoing Recovery Pending” state for the SSCOP. Eventually, the SSCOP state changes to “Data Transfer Ready” and the standby host thereby becomes the active host in a transparent manner to the SSCOP user regarding for the links, for which failover has been performed.

These and other objects of the invention, as well as many of the intended advantages thereof, will become more readily apparent when reference is made to the following description, taken in conjunction with the accompanying drawings.

### BRIEF DESCRIPTION OF THE FIGS.

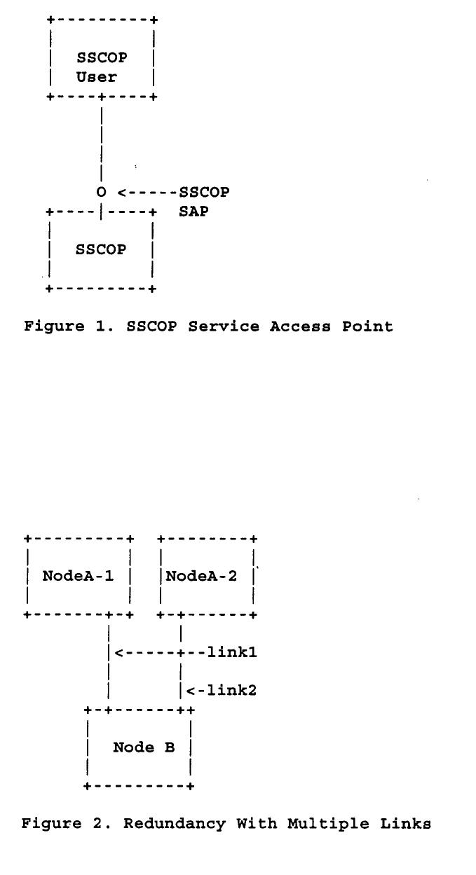

FIG. 1 is a block diagram of the SSCOP Service Access Point;

FIG. 2 is a block diagram showing redundancy using multiple links between nodes;

FIG. 3 is a block diagram showing redundancy with multiple instances of the same link;

FIG. 4 is a model of a conventional SS7 protocol stack;

FIG. 5 depicts a conventional SS7 link using SSCF-NNI/SSCOP connection;

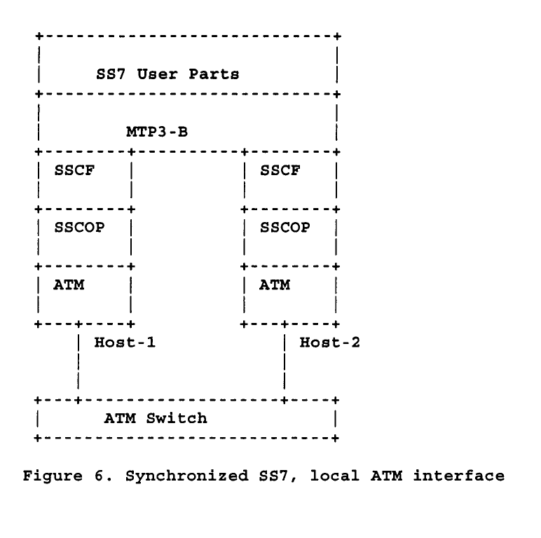

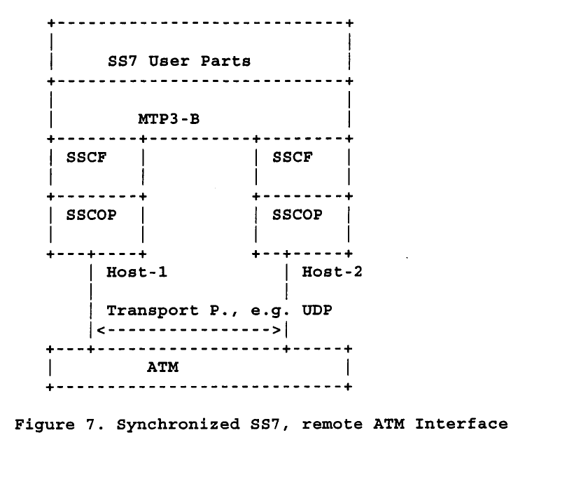

FIG. 6 is block diagram of a synchronized SS7 system with a local ATM interface;

FIG. 7 is a block diagram of a synchronized SS7 system with a remote ATM interface;

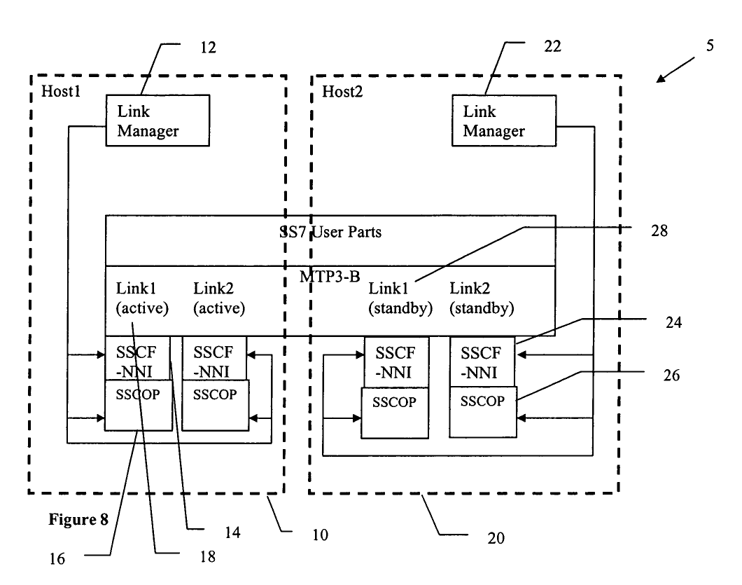

FIG. 8 is a block diagram of the system in accordance with the preferred embodiment of the invention with architecture for a remote ATM interface;

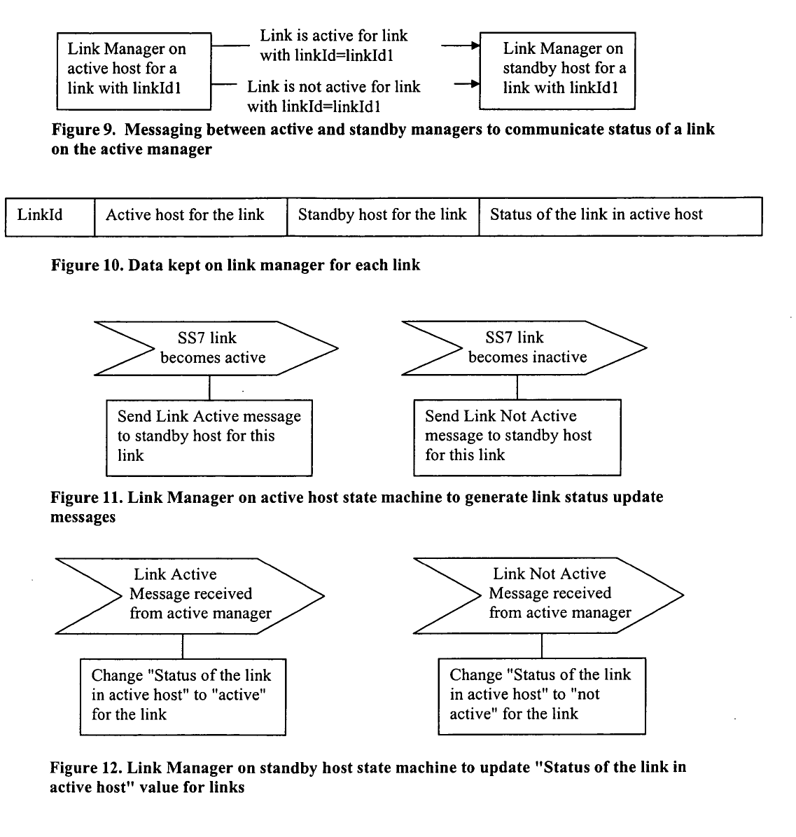

FIG. 9 shows messages sent by the Link Manager for an active host to the Link Manager for a standby host to convey information about the status of a link;

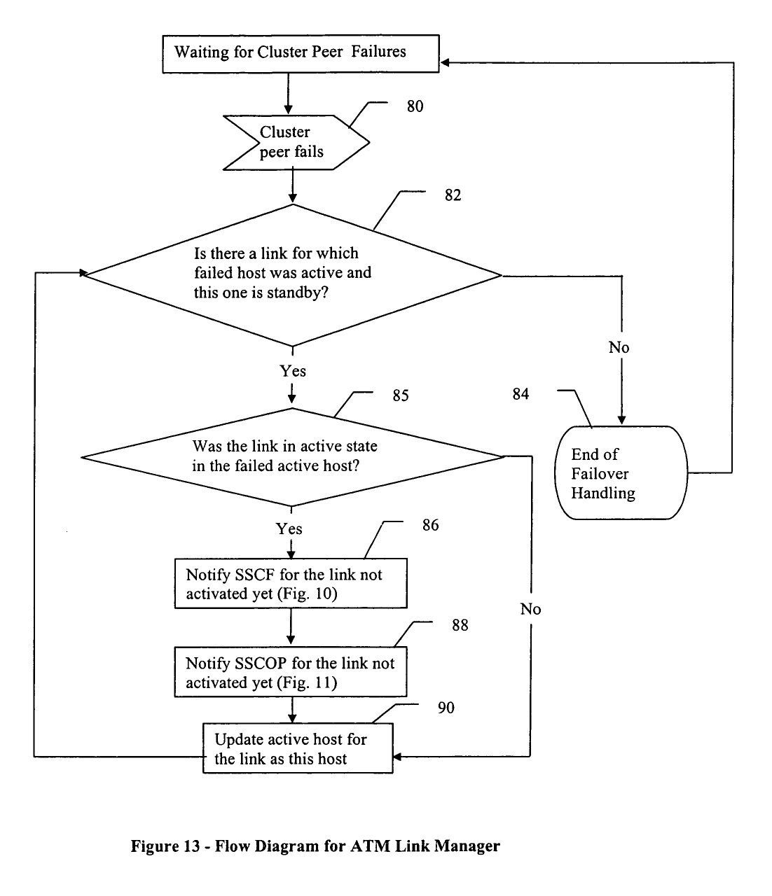

FIG. 10 shows data kept on a Link Manager for each link;

FIG. 11 shows the message processing on Link Manager on the active host to update status of the links;

FIG. 12 shows the message processing on Link Manager on the standby host to update status of the links;

FIG. 13 is a flow chart depicting operation of the Link Manager for a link for which its host is configured as a standby;

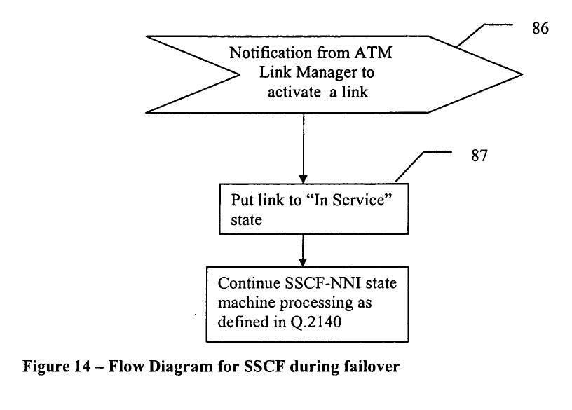

FIG. 14 is a flow chart depicting operation of the SSCF-NNI in the system of FIG. 8 when failover is performed; and,

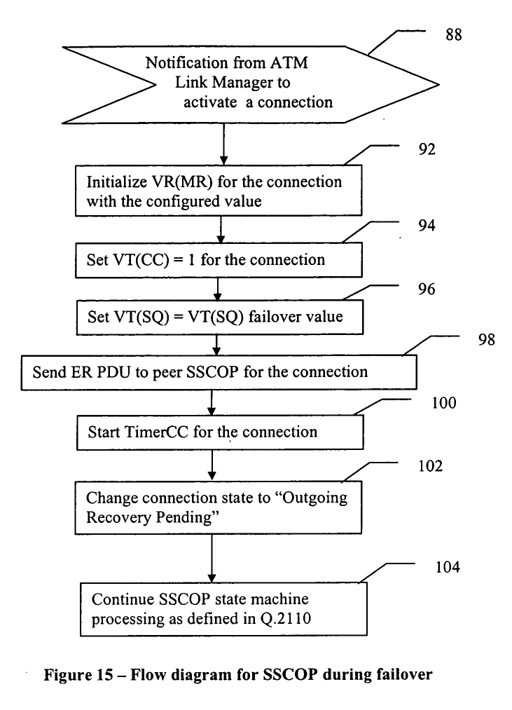

FIG. 15 is a flow chart depicting operation of the SSCOP in the system of FIG. 8 when failover is performed.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents that operate in similar manner to accomplish a similar purpose.

Turning to the drawings, FIG. 1 shows an SSCOP having a SAP that is accessed by an SSCOP user. The system provides failover of the SAP to a standby instance of the SAP in an almost transparent way to SSCOP users. In addition, the synchronized SS7 architecture can be used whether the ATM interface is local (FIG. 6) or remote, to provide synchronization on upper layers, i.e. MTP3 and SS7 user parts and if necessary TCAP. (FIG. 7). The graceful failover of the SSCOP connection can be utilized by any SSCOP user, as long as they don't fail their own service access point when receiving Recovery Indication (i.e., AA-RECOVER indication primitive) primitive from SSCOP and they reply with Recovery Response (i.e., AA-RECOVER response primitive) primitive and as long as there is an entity notifying standby SSCOP instance about the failure of the active instance (which can be provided by a Link Manager for the SS7 link case).

FIG. 8 is an illustrative embodiment of the system architecture 5 for a remote ATM interface. SS7 User Part and if necessary TCAP stacks and MTP-B layer are distributed on two hosts 10, 20, so that the MTP3-B state information, the SS7 User Part information and if necessary TCAP dialog state are synchronized. The information is synchronized so that the state information for MTP3-B and SS7 User Parts is the same on hosts 10 and 20.

This information contains availability/reachability status of the peer entities. MTP3-B instead of conventional MTP3 is used because it is the standard MTP3 variant to be used when SS7 link traffic is running over SSCF-NNI/SSCOP. Furthermore, MTP3-B is enhanced to support active and standby instances of the same SS7 link simultaneously on two hosts, so that MTP3-B uses the SS7 link instance on the host, which is active for the corresponding SS7 link.

Each host 10, 20 has a Link Manager 12, 22, SSCF-NNI layers 14, 24, and SSCOP layers 16, 26. For each link 18, 28, there is an instance of SSCF-NNI state machine running in layers 14, 24 (i.e., the SSCF-NNI state machine/procedures of Q.2140) and similarly for each link there is an instance of SSCOP state machine running in layers 16, 26 (i.e., the SSCOP state machine/procedures of Q.2110). The link managers 12, 22 are aware of the existence of the links 18, 28, which represent a logical connection between two entities and need not be physical entities.

The system 5 can be implemented by a single process that operates the link manager 12, 22, SSCF-NNI 14, 24 and SSCOP 16, 26. Alternatively, the link manager 12, 22, SSCF-NNI 14, 24 and SSCOP 16, 26 can be kernel modules or different processes/threads. Other implementations will be apparent without departing from the scope of the invention. The link manager also performs managerial activities for SSCF-NNI and for SSCOP, e.g., creating the SSCF-NNI and SSCOP instance, and sending them failover messages.

The system need not have any specific architecture in terms of physical hardware used. Rather, the system can be implemented on any computing platform including (preferably) general purpose computers, e.g., PCs and servers, or can be implemented as a specially designed hardware, e.g., an ASIC.

For each link, for which a host is configured as a standby, the Link Manager 12, 22 has information about the identity of the active host 10, 20, e.g. IP address and network name (FIG. 10). That information can then be used to perform health checking on the active host for that link. A messaging/notification mechanism is provided between the ATM Link Manager 12, 22 and the respective SSCF-NNI 14, 24, as well as between the ATM Link Manager 12, 22 and the respective SSCOP 16, 26.

Each host 10, 20 assumes the role of either the active or standby host for a particular link. Thus, for each link, one host will be configured as active host and one host will be configured as standby host. This configuration is done through MML (Man Machine Language) commands or through configuration files.

The SSCF-NNI and SSCOP instances for a link on the active host for that link are in “In Service” and “Data Transfer Ready” states respectively after the connection establishment and link alignment procedures, described in Q.2110 and Q.2140 respectively. The SSCF-NNI and SSCOP instances for a link on the standby host for that link are in “Idle” state. The active host and the standby host exchange messages to perform health checking so that standby can detect if active host goes down. In addition, as shown in FIGS. 9, 11 and 12, the active and standby link managers 12, 22 exchange data about the status of links.

As shown in those figures, when a link becomes active on the active host, the link manager for the active host sends a message to the link manager on the standby host to inform it of the new active status for this link. Similarly, when a link becomes inactive on the active host, the link manager for the active host sends a corresponding message to the link manager for the standby host. Each link in those messages is identified by an identifier called linkid, which uniquely identifies a link in the system. Accordingly, after a failover the standby host can attempt to activate only the active links.

Preferably, there is only one standby host, because after an active host fails, only one standby host should assume the new active role. Of course, multiple secondary standby hosts can be provided, where one of them could become the primary standby after the initial primary standby becomes active.

The system of the invention provides a Synchronized SS7 system, whereby certain protocol state information is synchronized between instances on different hosts for MTP3-B, SS7 User Parts and if necessary for TCAP. Thus, when one instance fails, the other one can take over its role with no effect to the rest of the network.

FIGS. 13-15 depict the operation of a host 10, 20 that is a standby for a particular link for each of the ATM Link Manager 12, 22 (FIG. 13), the SSCF-NNI stack 14, 24 (FIG. 14), and the SSCOP stack 16, 26 (FIG. 15). The SSCF-NNI stack 14 and the SSCOP stack 16 are both in an “Idle” state for the particular link. The SSCF-NNI 14, 24 and SSCOP stacks 16, 26 generally operate in accordance with their relevant ITU specifications in order to implement their operations. The operations of FIGS. 13-15 are local to the system 5, so that the peer can operate as normal in accordance with ITU protocols.

Beginning with FIG. 13, the ATM Link Manager 12, 22 detects or is informed about that active host is down, step 80. In step 80, the Link Manager is receiving the notification/event or detecting that an active host failed. The detection can be accomplished in any suitable manner, such as by using a heartbeat exchange or another entity could notify ATM Link Managers of status changes for other hosts in the redundancy group. For instance, the link manager for the standby host can periodically send heartbeat messages to the link manager for the active host. When the link manager for the standby host receives a heartbeat message, it replies back with another heartbeat message. If the link manager for the standby host does not receive a heartbeat message as a response from the link manager for two consecutive heartbeat messages it sent, it identifies the active host as failed.

To provide redundancy on the communication path between active and standby hosts, SCTP with multihoming feature is used where for each SCTP path a different network is utilized. At step 82, the Link Manager is checking for each individual link, whether failover needs to be performed for it, after the event in 80 has been received. The Link Manager 12, 22 then checks its links (for which it is the standby host) to detect whether the active host 10, 20 for a link has failed, step 82. If no link is detected for which the failed host was active and the present host is standby, step 82, then failover handling ends, step 84, and it returns to waiting for cluster peer failures.

For the links for which the failed host was the active host and the link was in the active state, step 85, the link manager for the standby host updates “Active host for the link” and “Standby host for the link” data, by declaring itself as the active host for the link and selecting another host as the standby host for this link. Step 82 checks whether the failed host was the active host for a particular link, whereas step 85 checks whether that link was in “active” state before failure of that host. This could be the failed host or another host selected based on configuration data. If the link was not in active status in the failed host, step 85, then no special processing is performed regarding SSCF-NNI and SSCOP and processing continues with the next link, step 90.

When the failure of a host in redundancy group is detected for a local ATM interface case, the entity performing the ATM functions is informed so that it starts to accept traffic for the corresponding ATM connection in both directions. When the failure of a host in redundancy group is detected for remote ATM interface case, depending on the transport mechanism used between the ATM interface and the rest of the protocol stacks, the protocol stack side starts serving the network address for the failed entity and if a connection oriented transport mechanism is used, establishes the connection to ATM interface side. For example, if UDP (User Datagram Protocol) is used as the transport mechanism, protocol stack side would takeover the IP address of the failed host and there won't be a need for any other procedure because UDP is a connectionless mechanism.

Once a Link Manager detects that a host on the redundancy group has failed, it checks its list of links, whether the failed host was the active host for those links. If the Link Manager 12, 22 determines that the active host has failed and if the link was in active state on the failed active host, it informs the SSCF-NNI 14, 24 about the loss of active replica of the link, step 86. This can be done by sending an internal message to the SSCF-NNI 14, 24. The SSCF-NNI 14, 24 puts the corresponding link state machine to the “In Service” state, step 87, as shown in FIG. 10. When the SSCF-NNI 14, 24 is in the “In Service” state, it can send and receive data messages.

The “In Service” is a state of the SSCF-NNI state machine in accordance with the ITU guide, whereby the SSCF-NNI state machine is operational and ready to exchange messages. The SSCF-NNI state machine must be placed in the “In Service”state before changes associated with this invention are applied to SSCOP layer. This ensures that the SSCF-NNI responds with the AA-Recover-Response primitive when the SSCOP sends AA-Recover-Indication primitive. The SSCOP sends the AA-Recover-Indication primitive to the SSCF-NNI when it receives an ERAK PDU from the peer SSCOP at the end of the recovery procedure. The SSCF-NNI replies with an AA-Recover-Response primitive so that both the SSCF-NNI and the SSCOP will be ready to transfer user traffic at the end of recovery procedure.

The ATM Link Manager 12, 22 also informs the SSCOP 16, 26, about loss of active replica of the link, step 88. This can be done by sending an internal message. Turning to FIG. 11, the SSCOP 16, 26 initializes VR(MR) (which is the maximum acceptable receive state variable) with the initial window size granted to the peer transmitter, step 92. The initial window size determines how many messages can be received from the peer, without any message being acknowledged by SSCOP (i.e., the local SSCOP). Each message that is received has a sequence number. When the messages are sent by the remote SSCOP, the remote SSCOP should not exceed a certain sequence number since otherwise it will exceed the number of messages capable of being received by the peer SSCOP (i.e., its initial window size).

The initial window size is a parameter which needs to be configured for SSCOP and is defined by the Q,2110 ITU SSCOP specifications. The VR(MR) is set to the initial window size to start communicating messages over this connection since the SSCOP on the standby host 16, 26 doesn't have any received and unacknowledged messages for this SSCOP connection and after receiving the ER PDU sent in 98, the remote SSCOP will start using sequence numbers beginning with 0 for SD PDUs.

The VR(MR) is used to determine the sequence number of the first SD PDU (Sequenced Data Protocol Data Unit) (data message) not allowed by the receiver (i.e., the receiver functionality of the peer SSCOP entity). The VR(MR) contains the sequence number of the first PDU that is not accepted by the receiver, so that the message sent will have a sequence number that is less than that value, i.e., the receiver will allow up to VR(MR)-1. After a recovery procedure (i.e., under Q.2110, when two SSCOP instances are communicating with each other, after one of them sends ER PDU), the sequence numbers will be reset to 0, so that the sequence number for the messages to be received by the peer SSCOP is limited to the initial window size.

The SSCOP 16, 26 sets the VT(CC) variable (the connection control state variable) to 1, step 94, because SSCOP is going to send ER PDU in step 98 and this will be first transmission of this ER PDU message. The ER PDU is sent to reset SSCOP state variables on the peer SSCOP to avoid data message from being dropped after failover. The VT(CC) holds the number indicating how many times a BGN(begin), END(end), ER(error) or RS(resynchronization) PDU has been transmitted. For the first transmission of such a PDU, VT(CC) is set to 1 and for each retransmission it is increased by 1. Such a PDU will be retransmitted if no corresponding acknowledgement, e.g., ERAK PDU for ER PDU, is received before retransmission timer, i.e., TimerCC in SSCOP protocol, expires. When VT(CC) exceeds a preconfigured threshold value, this is considered as a serious error and the connection is dropped because the PDU is retransmitted for several times but no reply has been received from the peer SSCOP.

Because step 98 is the original transmission of ER PDU, VT(CC) is set to 1 to indicate that no retransmission of this ER PDU has occurred yet and that this is the first transmission of the message. If the ER PDU is retransmitted because no ERAK PDU acknowledgement is received, it will be retransmitted and with each retransmission VT(CC) will be increased by one. If the VT(CC) value reaches the preconfigured maximum retransmission threshold, SSCOP connection will be dropped.

The SSCOP 16, 26 sets VT(SQ) variable (the transmitter connection sequence state variable) to the current VT(SQ) failover value, step 96. The VT(SQ) is used to allow the receiver to identify retransmitted BGN, ER, and RS PDUs. The receiver keeps the VT(SQ) value of the last message containing this field. Whenever a message containing VT(SQ) filed is received, i.e., BGN, ER or RS PDU, the receiver compares the VT(SQ) value in the received message with the VT(SQ) value it stored last. If those two values are the same, the received message is considered as a retransmission of a previously received message. VT(SQ) is initialized to 0 upon creation of the SSCOP process in accordance with ITU specifications for the SSCOP. The value for VT(SQ) is incremented before the initial transmission of either a BGN, RS, or ER PDU so that the new message has a different VT(SQ) value than the previous ones. Thus, the VT(SQ) value will be different for each original transmission of such message because the VT(SQ) is first increased by 1 and then used to populate the message.

It is important that ER PDU sent in step 98 not be interpreted as a retransmitted ER PDU by the peer SSCOP. If it is interpreted as a retransmission, the peer SSCOP won't perform a full SSCOP state machine processing when it receives the ER PDU because it will assume that the original transmission of this ER PDU has already been received and processed fully by it. This would result in the SSCOP state variables not being reset properly by the peer SSCOP, which in turn would prevent the SSCOP connection to function properly after the failover procedure and cause other SSCOP errors for this connection causing it to be dropped.

It is important that the received ER PDU sent in step 98 is not detected as a retransmission by the peer SSCOP. To do so, an appropriate VT(SQ) value is used when sending the ER PDU message. Two different mechanisms are provided to ensure that a proper VT(SQ) value is used while sending ER PDU.

The first mechanism relies on static configuration. Each host is assigned a static failover VT(SQ) value, which is unique in the redundancy group, to be used as the VT(SQ) value after failover, i.e., to be used while sending ER PDU during failover. The VT(SQ) is incremented a) with BGN PDU, which is sent once during SSCOP connection establishment, and b) with ER PDU and RS PDU, which are sent to recover from unexpected/failure situations. These situation are considered anomalies and happen because of reasons like lost messages.

Considering the high reliability of ATM networks, which is used to carry SSCOP messages, it is extremely unlikely that such situations will happen often other than due to a fault in the active host. Because BGN PDU is sent only once and ER PDU/RS PDU are not expected to be sent often, any value larger than 20 is considered to be reasonable large. This value is can be chosen through configuration and will be referred to as the VT(SQ) increment value.

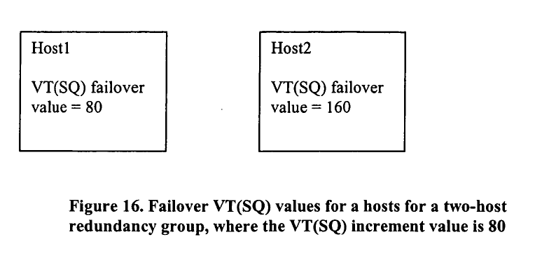

While assigning static VT(SQ) failover values, the following algorithm is preferably followed. Initially, the VT(SQ) failover value for the first host is set to equal the VT(SQ) increment value. The VT(SQ) failover value for the other hosts are then set to the VT(SQ) failover value of the previous host, plus the VT(SQ) increment value, as shown in FIG. 16. FIG. 16 shows the static assignment of VT(SQ) failover values for a system consisting of two hosts, where VT(SW) increment value is 80.

The VT(SQ) increment value assures that after a failover, the VT(SQ) value in the SSCOP on the newly active host is different than the VT(SQ) value of the SSCOP on the failed host. By using a sufficiently large value as the VT(SQ) increment value, it is extremely unlikely that the number of BGN PDUs, ER PDUs and RS PDUs sent between failovers will be equal to the VT(SQ) increment value.

The second method used to ensure that a proper VT(SQ) value is used while sending ER PDU, relies on dynamic synchronization of VT(SQ) values between SCCOP instances on active and standby hosts. Considering that BGN PDU, ER PDU, and RS PDU are sent very rarely, and that VT(SQ) is incremented when one of those PDUs is sent, synchronizing VT(SQ) values between two SSCOP instances does not cause a significant messaging overhead. This synchronization can be achieved either by direct messaging between SSCOP instances, or other entities could relay those messages. For example, the SSCOP on the active host informs the Link Manager on the active host about the VT(SQ) update, and the Link Manager on the active host sends a message to the Link Manager on the standby host, and then the Link Manager on the standby host informs SSCOP instance on the standby host. Thus, the VT(SQ) information is conveyed to the standby host.

The standby SSCOP instance uses the VT(SQ) failover value=VT(SQ) value from the update message +2. This ensures that VT(SQ) value to be used while sending ER PDU during failover processing is different than the VT(SQ) value of the SSCOP instance on the failed host. The rationale behind adding 2 to VT(SQ) value in the update message is that 1 is added to increment VT(SQ) value so that it is different than the last used VT(SQ) value. Another 1 is added to cover the cases, where the active host fails, where its VT(SQ) value is incremented but the corresponding update message is not sent yet.

The SSCOP 16, 26 sends ER PDU to the peer SSCOP for the connection, step 98. This puts the peer SSCOP (i.e., the the SSCOP instance on the entity with which we are communicating, to “Incoming Recovery Pending” state. The purpose of this isn to reset state variables on the remote SSCOP without dropping the connection. The state variables are reset on the peer SSCOP in accordance with procedures defined in Q.2110, since the current values are not known after the active host is down and failover happens.

The SSCOP 16, 26 sets TimerCC for the connection, step 100. The TimerCC is started so that if ER PDU sent in step 98 is lost, it can be resent (according to Q.2110, when TimerCC expires while SSCOP is in “Outgoing Recovery State”, ER PDU is resent). The ER PDU can be lost if it is sent through the ATM network and an ATM switch on the path drops it due to an overload or if there is some other failure causing the content of the message getting corrupted. The SSCOP 16, 26 also changes to “Outgoing Recovery Pending” state, step 102. The ER PDU is sent to the peer so that the SSCOP can start to follow SSCOP state machine definitions in Q.2110. The SSCOP is put to “Data Service Ready” when an ERAK (Error Recovery Acknowledge) PDU is received from the peer.

When the SSCOP is in the “Data Service Ready” state, it can send and receive SD PDUs. The SD PDUs are used to send/receive user messages, e.g., SS7 link messages. Once the SSCOP is in “Outgoing Recover Pending” state, it starts to follow Q.2110 without any deviations, step 104. Using the ER PDU instead of a proprietary message allows the invention to be used without expecting any special behavior from peer SSCOPs. Accordingly, there won't be any interoperability problems, as long as the peer SSCOP is fully compliant with Q.2110.

After that point on, everything continues as defined by corresponding protocol specifications Q.2110. At step 90, the link manager modifies the data associated with this link by updating “Active Host for the link” value with the identifier of the local host.

The ATM Link Manager 12, 22 keeps information about each individual SS7 link running on top of ATM through SSCF-NNI/SSCOP, whether the host is configured as active or standby for this link. The ATM Manager stores for each link (for which the manager is standby) a link identifier, the identifier for active host, and the current status of the link on active host. The ATM Manager for each link (for which the manager is active) stores link identifier, the identifier for the standby host and the current operational status of the link as either “active” or “standby.” Links can be put in service or taken out of service administratively, and can also fail due to network failures and switch to “standby” state.

In accordance with the preferred embodiment of the invention, the system is used for SS7 links running on top of SSCF-NNI/SSCOP, to handle failover cases without loss of SS7 link SAP, so that failover happens in an almost transparent way to MTP3-B and SS7 User Parts. Any SSCOP user, such as an SSCF-NNI user, can benefit from this invention given that it satisfies the constraints mentioned above—that the SSCOP-user should stay in “In Service” (or whatever is the state corresponding to normal operational state for that SSCOP-user) when it receives AA-Recover-Indication primitive from SSCOP, and that the SSCOP-user must reply with an AA-Recover-Response primitive to the SSCOP after receiving the AA-Recover-Indication primitive from the SSCOP.

The SSCF-NNI is just one such SSCOP-user which satisfies the criteria listed above and thus can be used as SSCOP-user in a system utilizing the invention. As one illustrative example of the invention, SS7 links can be used running on SSCOP connections

The invention also need not be dependant on an ER PDU signal, but can use any suitable signal such as RS (Resynchronization) PDU. It is noted that some loss may occur of messages which were sent by application on the previous active host but could not be delivered to the network because that host going down. Also, messages which are sent by the remote application, and which were in the network while the active host failed, may also be lost. However, the effects of those losses can be accounted for by mechanisms implemented in MTP3-B/SS7 User Parts, such as for instance by providing timeout mechanisms. The ability of the invention to not lose the SS7 link SAP is important because it allows uninterrupted operation of the MTP3-B, SS7 User Parts and is transparent to user applications.

This setup is especially useful to implement the Protection Group (i.e., Redundancy Group) approach for an SS7 link, in the context of ATCA, where physical ports and service interfaces are managed by a system wide Interface Management entity. The Protection Group approach requires that when a failure happens on a service access point, its replica in the redundancy group continues to provide the same service in a transparent way to the users of service access point.

Without the invention, failover from the active member of the redundancy group to the standby one does cause the SSCOP connection to be lost, so that the failover is not transparent.

The invention requires some changes in the local SSCOP stack, but does not require any changes in the peer SSCOP, i.e., there are no interoperability issues associated with this invention. Accordingly, there is no special behavior required from the peer SSCOP, which is able to follow the standard specifications of the ITU. Accordingly, the system 5 of the present invention can be used to communicate with any remote system conforming to the ITU standards.

Accordingly, the system 5 is able to handle uncontrolled switchover/failover cases for SSCOP SAP. Moreover, it does so in a transparent manner to the local MTP3-B/User Parts and to the remote peer inline with the redundancy group concept of ATCA platforms. The switchover/failover is transparent since the SS7 link (both on MTP3-B layer 2 and SSCF-NNI layer 4) is not dropped. The SS7 link is not dropped because the SSCOP connection is not dropped. That is, the SSCOP SAP does not fail—even though messages may be lost, this does not cause the SSCOP SAP to fail, so that the SSCF-NNI SAP also does not fail, which in turn allows the SS7 link to stay active.

After receiving the AA-Recover-Indication, the SSCF-NNI replies with a Recover-Response primitive. Some SD PDU data messages may be lost. The invention can be used to replicate links in any configuration, including multiple link redundancy and linksets. One advantage over the linkset approach of FIG. 2 is that invention is inline with redundancy concept as defined for a protection group, whereas the linkset approach is not in line with the redundancy concept.

In addition, the invention does not initiate a new connection, which is advantageous because the failover wouldn't be transparent to the remote system if a new SSCOP connection were established. The remote system would recognize the failover because a BGN PDU is sent to establish a new SSCOP connection. This would trigger an AA-RELEASE indication to be sent by the peer SSCOP to its user, i.e., to the peer SSCF-NNI in our case, according to Q.2110. This would cause the SS7 link to be put out of service. It also is able to use the error recovery mechanism of SSCOP, after a failover of the active host, when the SSCOP instance on standby host assumes an active role, so that SSCOP connection does not fail.

The advantage of the error recovery mechanism of SSCOP is that the system doesn't expect some special behavior from the peer SSCOP entity, i.e., it just needs to follow Q.2110 without any modifications. All deviations from Q.2110 are local and have the purpose to prepare the local SSCOP for “Outgoing Recover Pending” situation. When the ATM Manager notifies the SSCF-NM and the SSCOP, the SSCF-NNI and SSCOP are then prepared for SSCOP error recovery mechanism so that the SSCF-NNI/SSCOP state variables are prepared for a situation occurred causing SSCOP to send ER PDU and we send ER PDU ourselves. Furthermore, the VT(SQ) variable is set so that ER PDU sent is not identified as a retransmission by the peer SSCOP.

This also prevents the failure of corresponding SS7 link. Because the invention does not require a new SSCOP connection to be established, it prevents a SS7 link failure. If during failover the SSCOP connection fails (which is the case without using this invention), the SSCF-NNI will be notified and the SSCF-NNI will fail SS7 link. The invention prevents SSCOP connection failure so SSCF-NNI does not fail the SS7 link. Furthermore, certain SSCOP state variables are initialized and/or set to specific values so that ER PDU (Error PDU) won't be detected as a retransmission on the peer SSCOP and sending/receiving of messages afterwards could happen according to the specifications of the SSCF-NNI and SSCOP protocols. If the ER PDU is detected as a retransmission by the remote SSCOP, the remote SSCOP won't process the ER PDU as a original ER PDU and won't reset SSCOP state variables properly. This would cause the SSCOP connection not to function properly to transfer user data messages.

In accordance with the preferred embodiment, two architecture models are considered for Synchronized SS7 : (1) Synchronized SS7 having a local ATM interface (FIG. 6); and (2) Synchronized SS7 having a remote ATM interface (FIG. 7). Local ATM interface (FIG. 6) refers to the case where ATM layer functionalities are provided on the same host together with the upper protocol layers, usually through a special purpose ATM card. In this configuration, an ATM switch send and receives traffic from two ATM cards.

Although the invention is preferably used for graceful failover of SSCOP service access point, other applications are apparent. For instance, the invention need not only be used for the case where SS7 link traffic is carried over SSCOP. Rather, when the layer above SSCOP receives Recover-Indication primitive from the SSCOP (a primitive provided for in Q.2110), it should reply with Recover-Response primitive (also provided for in Q.2110) as well, and should not change its state, which may be “In Service,” “Data Transfer Ready,” etc., depending on the type of layer above SSCOP. The behavior of other states is immaterial because during failover process we artificially will put the layer above SSCOP to “Outgoing Recover Pending” state, which would change to “Data Transfer Ready” state according to Q.2110 when ERAK PDU is received from the peer SSCOP. In addition, the invention can be applied to other types of SSCF, such as SSCF-UNI.

Remote ATM interface (FIG. 7) refers to the case where ATM layer functionalities are provided on another host than the one were upper layer protocols are running, again usually through a special purpose ATM card. Communication between those hosts could be based on any transport layer protocol, e.g., UDP. In this configuration, SSCOP communicates only with one ATM interface. It should be noted that the ATM interface side could also utilize the concept of redundancy group, with failovers transparent to other entities, e.g., to the host serving the rest of the protocol stacks. It should also be noted that, in the embodiment of FIG. 7, the vertical line between host and ATM does not indicate a connection, but the fact that a single ATM service point is accessible from both of the hosts.

The hosts 10, 20 can be implemented in any type of physical computing element, e.g. PCs, servers, specially designed ASICs. Link Managers 12,22, SSCF-NNI stacks 14, 24, SSCOP stacks 16, 26 can be implanted as different processes, as threads, as kernel modules or any combination thereof. Preferably, the Link Manager is a process and the SSCF-NNI and SSCOP are separate kernel modules, which provides modularity and high performance.

The foregoing description and drawings should be considered as illustrative only of the principles of the invention. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

1. A system for providing graceful failover for an SS7 link utilizing SSCOP connections to transfer data, the system comprising:
a first host that is active for the SS7 link; and,
a second host that is standby for the SS7 link, said second host having an SSCF-NNI module, an SSCOP module, and a link manager for determining whether said first host has failed and notifying said SSCF-NNI module and said SSCOP module if said first host has failed, whereby said SSCF-NNI and SSCOP modules become active for the link in response to being notified by the link manager that the first host has failed.

2. The system of claim 1, wherein the SSCOP module uses the transmitter connection sequence state variable, VT(SQ), to identify whether a data is a retransmission.

3. The system of claim 1, wherein the SSCOP module uses a preconfigured VT(SQ) value after failover.

4. The system of claim 3, wherein the VT(SQ) to be used after failover is obtained from the first host and synchronized on the second host.

5. The system of claim 1, wherein said second host comprises a processor that implements said link manager, SSCOP module, and SSCF-NNI module.

6. The system of claim 1, wherein said first host is sending and/or receiving data for the SS7 link.

7. The system of claim 1, wherein said SSCF-NNI module comprises an SSCF-NNI stack instance and said SSCOP module comprises an SSCOP stack instance.

8. The system of claim 1, wherein said SSCOP module comprises a state machine, and said SSCF-NNI module comprises a state machine.

9. The system of claim 1, wherein said first host comprises an active host for the link and said second host comprises a standby host for the link.

10. The system of claim 1, wherein said second host has determined that said first host is the active host for the link and that said second host is a standby host for the link.

11. The system of claim 10, whereby said SSCF-NNI module has a default standby mode, said link manager sends a signal to said SSCF-NNI module when the first host has failed, and said SSCF-NNI module enters an active mode in response to the signal.

12. The system of claim 11, wherein said SSCF-NNI module, in the standby mode, does not perform any functions with respect to the link.

13. The system of claim 11, wherein said SSCF-NNI module, in the active mode, performs at least one function with respect to the link.

14. The system of claim 11, wherein said SSCF-NNI module, in the active mode, performs all functions of a Q2140 standard.

15. The system of claim 11, whereby said SSCOP manager has a default standby mode, said link manager sends a signal to said SSCOP manager when the first host has failed, and said SSCOP manager enters an active mode in response to the signal.

16. The system of claim 15, wherein said SSCOP manager, in the standby mode, does not perform any functions with respect to the link.

17. The system of claim 15, wherein said SSCOP manager, in the active mode, performs at least one SSCOP-related function with respect to the link.

18. The system of claim 1, wherein said first host has an SSCF-NNI module, an SSCOP module, and a link manager for communicating with the link manager of said second host.

19. A system for providing graceful failover for a link, the system comprising:
a plurality of hosts, each host having an SSCF-NNI module for performing SSCF-NNI functions for said second host, an SSCOP module for performing SSCOP functions for said second host, and a link manager;
wherein each host is connected to the link and determines whether it is an active host or an inactive host for the link and, if it is the inactive host then determining whether the active host has failed and notifying said SSCF-NNI module and said SSCOP module to become active for the link when the first host has failed.

20. The system of claim 19, wherein each host determines whether it is an active host or an inactive host for the service access point based on a configuration for that host

21. A method for providing graceful failover for a SS7 link, the method comprising:
providing a first host connected to the link; and,
providing a second host connected to the link, the second host having an SSCF-NNI module for performing SSCF-NNI functions for the second host, an SSCOP module for performing SSCOP functions for the second host, and a link manager for determining whether the first host has failed and notifying the SSCF-NNI module and the SSCOP module to become active for the link when the first host has failed.

22. The method of claim 21, wherein the second host comprises a processor that implements the link manager, SSCOP manager, and SSCF-NNI module.

23. The method of claim 21, wherein the SSCOP module and the SSCF-NNI module each comprise a state machine.

24. The method of claim 21, wherein the first host comprises an active host for the SS7 link and the second host comprises a standby host for the SS7 link.

25. The method of claim 21, wherein the second host has determined that the first host is the active host for the link and that the second host is a standby host for the link.

26. The method of claim 25, wherein the second host has information that the first host is the active host for the link.

27. The method of claim 26, wherein the information is provided during configuration of the second host.

28. The method of claim 25, whereby the SSCF-NNI module has a default standby mode, the link manager sends a signal to the SSCF-NNI module when the first host has failed, and the SSCF-NNI module enters an active mode in response to the signal.

29. The method of claim 28, wherein the SSCF-NNI module, in the standby mode, does not perform any functions with respect to the link.

30. The method of claim 28, wherein the SSCF-NNI module, in the active mode, performs at least one SSCF-NNI-related function with respect to the link.

31. The method of claim 25, whereby the SSCOP manager has a default standby mode, the link manager sends a signal to the SSCOP manager when the first host has failed, and the SSCOP manager enters an active mode in response to the signal.

32. The method of claim 31, wherein the SSCOP manager, in the standby mode, does not perform any functions with respect to the link.

33. The method of claim 31, wherein the SSCOP manager, in the active mode, performs at least one SSCOP-related function with respect to the link.

34. A system for providing graceful failover for a SSCOP connection used to transfer data, the system comprising:
a first host that is active for the connection; and,
a second host that is standby for the connection, said second host having a communications module, and a manager for determining whether said first host has failed and notifying said communications module if said first host has failed, whereby said communications module becomes active for the connection in response to being notified by the manager that the first host has failed.
